(19) United States
(12) Patent Application Publication
(10) Pub. No.: US 2018/0220494 A1
(43) Pub. Date: Aug. 2, 2018

(54) METHOD FOR MANUFACTURING HEATING ELEMENT, HEATING ELEMENT MANUFACTURED THEREBY, AND USE METHOD THEREOF

(71) Applicants: Se Yeong KIM, Seoul (KR); Dong Woo KIM, Seoul (KR)

(72) Inventors: Se Yeong KIM, Seoul (KR); Dong Woo KIM, Seoul (KR)

(21) Appl. No.: 15/746,571

(22) PCT Filed: Jul. 8, 2016
(86) PCT No.: PCT/KR2016/007411

§ 371 Date: Jan. 22, 2018

(30) Foreign Application Priority Data
Aug. 13, 2015 (KR) 10-2015-0114303

(51) Int. Cl. H05B 3/56; H01B 13/02; H01B 13/00; H01B 13/14; H01B 13/06; H01B 7/00; H01B 13/08; H05B 3/12

(52) U.S. Cl. CPC H05B 3/56; H01B 13/02; H01B 13/0036; H01B 13/0221; H01B 13/14; H01B 1/02; H01B 7/0009; H01B 13/0016; H01B 7/0054; H01B 13/08; H05B 3/12; H01B 13/06

(57) ABSTRACT

The present invention relates to a method for manufacturing a heating element, a heating element manufactured thereby, and a use method thereof and, more particularly, to a method of manufacturing a heating element by combining a plurality of ultrafine wires having a high resistance value in a parallel structure in which the entire areas of the plurality of ultrafine wires contact each other, so that a combined resistance value is reduced while each of the ultrafine wires has a high resistance value to improve heat generating efficiency; the heating element; a use method thereof. The method for manufacturing a heating element forms an ultrafine wire having a high resistance value from a single metal or an alloy metal and then joins a plurality of ultrafine wires so as to be in contact with each other to form a single bundle resulting in a single-strand heating wire.

### TECHNICAL FIELD

The present invention relates generally to a method for manufacturing a heating element, a heating element manufactured thereby, and a use method thereof. More particularly, the present invention relates to a method for manufacturing a heating element, a heating element manufactured thereby, and a use method thereof, in which a plurality of ultrafine wires having a high resistance value are combined in a parallel structure such that the total areas thereof are brought into contact with each other, whereby each ultrafine wire has a high resistance value while a combined resistance value is reduced, thereby improving heat generating efficiency.

### BACKGROUND ART

An electric heating element that generates heat when electricity flows has a certain resistance value.

The resistance interferes with the flow of current to convert the electric energy into heat energy, thereby generating heat.

Although electric heating elements are used for numerous items in numerous fields, they are mainly used for heating or making hot water.

However, conventional electric heating elements (including heating wires) have the following problems.

First, efficiency to convert to heat energy is low compared to electricity consumption.

Thus, many current electric or heating wire products are not preferred over other heating methods because the electricity consumption is too high compared to the heating value.

Second, there is very little technology available to customize the heating element, so it is impossible to use it versatile.

To be widely used throughout the industry and to be electrically safe, it is necessary to be able to make heating wire (heating element) from tens to hundreds of thousands kinds by customizing the heating value or electrical characteristics (voltage, current, for AC, for DC, etc.) depending on the requirements of the site where demand or development is desired. However, currently developed heating wire and heating element technologies have very little customized manufacturing technology.

Third, electrical safety is very vulnerable.

Since a considerable number of electric heating elements (heating wires) currently developed and distributed have no uniform resistance value, there is a risk of fire, electric shock, short-circuiting, and it is unsafe because there is bias current drift on the part where the resistance value is not uniform.

Particularly, it is very vulnerable to electrical safety when mixing powder of polymer conductive (carbon, etc.) into a liquid binder to make it into an ink and coating it on a thread or coating on a surface in various combinations, that is, carbon heating elements are very vulnerable to electrical safety.

Fourth, the metal heating wire does not have the ability to maintain constant temperature in the material itself without a separate thermostat.

Using the metal heating wire that does not maintain a constant temperature may cause a fire if the power supply regulator or a separate thermostat fails.

Fifth, heating in a large space is almost impossible, and the whole space cannot be heated uniformly.

In the conventional heating element, since most of the generated heat is not radiant heat, heat should be transmitted in the form of the conduction heat or the convection heat, so heating in a large space is almost impossible.

That is, in a space with a large area, only the surrounding area with the heater is hot, and the space away from the heater is cold, and even if heat is blown by a hot air blower, there is a limit to blowing the entire large space.

Further, heating is not uniform in the whole space.

That is, the surrounding area with the heater is hot but the space away from the heater is cold, the space where the hot air reaches is hot but the space where the hot air does not reach is cold.

Even if there is a heating element (for example, a heating element containing carbon) that emits radiant heat, the distance of the radiant heat (distance of far infrared rays) is short, so heating in a large space is almost impossible.

Sixth, the heating element (carbon, etc.) generating some radiant heat does not have electrical stability and does not generate heat at high temperature, and the distance of far infrared rays is short, so heating in a large space is almost impossible.

The heating element generating radiant heat that is capable of solving the fifth problem is also dangerous because it is not actually electrically stable. Among the conventional heating wires, the heating elements generating radiant heat by containing a carbon content are usually used by mixing powder of polymer conductive (carbon, etc.) into a liquid binder to make it into an ink and coating it on a thread or coating on a surface in various combinations, but they are fundamentally less uniform in resistance value than metal heating elements (metal heating wires), and as the time goes by, the conductive powder breaks off due to the difference in the number of expansion and contraction between the conductive powder and the binder, whereby change in load (decrease in a heating value) becomes worse.

Further, even if the far-infrared radiation heat is generated in the material itself, heating element temperature cannot be raised to high temperature, whereby the distance of the radiant heat is short, so heating in a large space is almost impossible.

Further, the heating element, which is made by mixing conductive powder with liquid binder and inking it and applying it to other third object, generates heat in a PTC (Positive Temperature Coefficient) principle in which the intermolecular distance of the conductive powder is increased to increase the resistance value, thereby decreasing the value of current when the temperature rises, so there is a limit that the heating element cannot be heated to high temperature by the automatic constant temperature function.

Seventh, there is no heating element (heating wire) that can generate heat by directly connecting with solar power electricity because a heating element (heating wire) that performs a heating function at low voltage, especially DC low voltage power cannot be made.

Eighth, it is not efficient in boiling water.

There is no heating element technology that generates a high temperature in a long heating wire at a low voltage, especially at a working voltage of 24 V or less.

Ninth, it breaks easily due to no flexibility and weak tensile force, and has short service life by being easily hardened and breaking easily due to weak durability and strong oxidizing of the ninth problem, simultaneously

### DISCLOSURE

### Technical Problem

Accordingly, the present invention has been made keeping in mind the above problems occurring in the related art, and a first object of the present invention is to provide a method for manufacturing a heating element, a heating element manufactured thereby, and a use method thereof, in which a plurality of ultrafine wires having a high resistance value are combined in a parallel structure such that the total areas thereof are brought into contact with each other, whereby each ultrafine wire has a high resistance value while a combined resistance value is reduced, thereby improving heat generating efficiency and allowing super-high speed and super-high temperature heating.

Further, a second object of the present invention is to provide a method for manufacturing a heating element, a heating element manufactured thereby, and a use method thereof, in which a desired resistance value is achieved by changing a total combined resistance value of a plurality of ultrafine wires constituting a single bundle, whereby the heating element can be customized and thus the heating element can be used for a variety of purposes.

Further, a third object of the present invention is to provide a method for manufacturing a heating element, a heating element manufactured thereby, and a use method thereof, in which a uniform resistance value is achieved along an entire length of a heating element, whereby it is possible to improve electrical safety.

Further, a fourth object of the present invention is to provide a method for manufacturing a heating element, a heating element manufactured thereby, and a use method thereof, in which a plurality of ultrafine wires constituting a bundle are grouped into groups with different functions, wherein one group functions to continuously generate heat when current flows, and another group generates less heat after reaching a predetermined temperature and functions to allow the current to flow like a conductor rather than generating heat as becoming conductive, and these two ultrafine wire groups are combined to be bundled, whereby it is possible to maintain the constant temperature in the material itself without a separate thermostat.

Further, a fifth object of the present invention is to provide a method for manufacturing a heating element, a heating element manufactured thereby, and a use method thereof, in which a plurality of ultrafine wires are combined into one body to form a single-strand heating wire single-strand heating wire (heating wire), whereby reverse current or bias current drift is prevent, and thus it is possible to prevent overheating, ultrafine wire damage or fire.

Further, a sixth object of the present invention is to provide a method for manufacturing a heating element, a heating element manufactured thereby, and a use method thereof, in which a plurality of ultrafine wires are connected to a power supply line (wire) simultaneously to prevent the current from flowing through a part of the ultrafine wires or prevent the resistance value thereof from becoming uneven, whereby it is possible to prevent local overheating accidents.

Further, a seventh object of the present invention is to provide a method for manufacturing a heating element, a heating element manufactured thereby, and a use method thereof, in which SUS 316, a ready-made steel fiber (NASLON), or a special alloy is used as a material of an ultrafine wire, so the ultrafine wire has flexibility, strong tensile force and does not break well, and it also has strong durability and oxidation resistance and does not easily hardened or crushed, whereby it is possible to extend service life.

Further, an eighth object of the present invention is to provide a method for manufacturing a heating element, a heating element manufactured thereby, and a use method thereof, in which after a heating element is manufactured by adjusting a temperature of the heating element itself to a temperature range required in a field, the heating element is cut into a predetermined length to make units, with one unit being one circuit, and multiple circuits of the units are used by being connected in parallel with each other, whereby it is possible to uniformly heat a large space.

Further, a ninth object of the present invention is to provide a method for manufacturing a heating element, a heating element manufactured thereby, and a use method thereof, in which a heating element is allowed to generate high temperature heat with a low voltage, whereby it is possible to extend the usage range and possible to boil water efficiently.

### Technical Solution

In order to achieve the above object, according to some aspects of the present invention, there is provided a method for manufacturing a heating element, the method configured in such a way that an ultrafine wire having a high resistance value is formed by using a single metal or an alloy metal, and then a plurality of ultrafine wires formed by using the single metal or the alloy metal are combined to be brought into contact with each other, thereby forming a single bundle resulting in a single-strand heating wire.

According to some aspects of the present invention, there is provided a heating element being one bundled heating wire as a parallel combined structure configured such that a plurality of ultrafine wires having a high resistance value are brought into contact with each other to be bundled.

According to some aspects of the present invention, there is provided a method for manufacturing a heating element, the method configured in such a way that an end of the heating element is inserted into a connection terminal or a sleeve and a stripped part of a wire is inserted into the connection terminal or the sleeve to be overlapped with the plurality of ultrafine wires, and the connection terminal or the sleeve is pressed to connect the heating element with the wire.

### Advantageous Effects

According to the above described technical solution, the following effects can be obtained.

First, since a plurality of ultrafine wires having a high resistance value are combined in a parallel structure such that the total areas thereof are brought into contact with each other, it is possible to improve heat generating efficiency and possible to allow super-high speed and super-high temperature heating.

Second, since a desired resistance value is achieved by changing a total combined resistance value of a plurality of ultrafine wires constituting a single bundle, the heating element can be customized and thus the heating element can be used for a variety of purposes.

Third, since a uniform resistance value is achieved along an entire length of a heating element, it is possible to improve electrical safety.

Fourth, since a plurality of ultrafine wires constituting a bundle are grouped into groups with different functions, wherein one group functions to continuously generate heat when current flows, and another group generates less heat after reaching a predetermined temperature and functions to allow the current to flow like a conductor rather than generating heat as becoming conductive, and these two ultrafine wire groups are combined to be bundled, it is possible to maintain the constant temperature in the material itself without a separate thermostat.

Fifth, since a plurality of ultrafine wires are combined into one body to form a single-strand heating wire single-strand heating wire (heating wire), reverse current or bias current drift is prevent, and thus it is possible to prevent overheating, ultrafine wire damage or fire.

Sixth, since a plurality of ultrafine wires are connected to a power supply line (wire) simultaneously to prevent the current from flowing through a part of the ultrafine wires or prevent the resistance value thereof from becoming uneven, it is possible to prevent local overheating accidents.

Seventh, since SUS 316, a ready-made steel fiber (NASLON), or a special alloy is used as a material of an ultrafine wire, so the ultrafine wire has flexibility, strong tensile force and does not break well, and it also has strong durability and oxidation resistance and does not easily hardened or crushed, it is possible to extend service life.

Eighth, since after a heating element is manufactured by adjusting a temperature of the heating element itself to a temperature range required in a field, the heating element is cut into a predetermined length to make units, with one unit being one circuit, and multiple circuits of the units are used by being connected in parallel with each other, it is possible to uniformly heat a large space.

Ninth, since a heating element is allowed to generate high temperature heat with a low voltage, it is possible to extend the usage range and possible to boil water efficiently.

### DESCRIPTION OF DRAWINGS

FIG. 1 is a view showing an embodiment of a heating element according to the present invention

### MODE FOR INVENTION

Hereinafter, an embodiment of the present invention will be described with respect to its configuration and operation.

### Embodiment 1

An quantity of heat Ω generated by a heating element is determined by the following equation: Q=0.24×I2×R×T.

Herein, I is the current supplied to the heating element, R is the resistance value of the heating element, and T is the time to supply the heating element with current.

In the equation, it can be seen that the heat generated by the heating element itself is proportional to the resistance value (R) and the current supply time (T), and is proportional to the square of the current amount (I).

Accordingly, in order to allow the heating wire to generate heat efficiently, it must be a high-resistance structure and a structure allowing more current to flow during ΔT, and skin effect of the resistor must be reduced.

To be more specific to the skin effect, under the test, the resistor also produces a skin effect as in a conductor.

That is, as the cross-sectional area of the resistor allowing current to flow increases, the surface of the resistor becomes less resistive due to the skin effect, and becomes extremely conductive, and the current flowing through the surface is caused to flow away without working (heating), which causes wasted current.

The skin effect significantly reduces the heat generation efficiency of the resistor, resulting in a much lower quantity of heat than Joule's Low compared to the power consumption.

Thus, in order to minimize the inefficient structure due to the skin effect, the surface area of the resistor must be small.

For example, when a heating wire having a resistance value of 1Ω per 1 m, assuming that a cross-sectional area allowing current flow is required to have a thickness of 1, it is possible to eliminate the skin effect much more when a single tube is made by combining a plurality of pieces which are made by dividing the cross-sectional area than when a single tube is made by using one cross-sectional area, so that a more efficient heating structure is obtained.

Accordingly, a structure of a heating wire (heating element) having an efficient heating structure is configured such that a plurality of ultrafine wires having a high resistance value are combined in a parallel structure such that the total areas thereof are brought into contact with each other, whereby each strand has a high resistance value while a combined resistance value is reduced, and the smaller the cross-sectional area, the better the structure.

when the heating wire (heating element) is manufactured in this method, a larger amount of current can flow instantaneously into the ultrafine wire assembly of multiple strands, a high-resistance structure, and simultaneously, it is possible to minimize the skin effect, whereby the heating wire of this structure is a high-efficiency structure that can eventually consume a small amount of power (efficiently) while achieving a high heating value.

Accordingly, the principle by which the high-efficiency (a large quantity of heat to be generated with small power consumption) heating wire or heating element is made is as follows: when a plurality of ultrafine wires each having a high resistance value are overlapped to be bundled (combined), although the actual resistance value of each ultrafine wire is high, a plurality of ultrafine wires are combined in a parallel structure, whereby a combined resistance value is reduced, and in the entire heating wire, the resistance value is lowered, resulting in a structure capable of flowing a large amount of current while having a high resistance value, resulting in a high-efficiency heating operation.

Actually, each strand of ultrafine wires can maintain a high resistance value with a large amount of current, so high quantity of heat (high temperature) is instantly generated in each strand, and further, the strand is too ultrafine to generate skin effect, thereby having a high-efficiency heating structure.

Further, each of the plurality of ultrafine wires instantly performs super-high speed and super-high temperature heating, and the instantaneous heating values of the bundle are combined to result in a high-efficiency heat state, and thus, the more these structures are strengthened, the more super-high efficiency heat generation will occur.

A method for manufacturing a heating wire (heating element) having the high-efficiency heating structure is configured, for example, in such a way that firstly, a plurality of ultrafine wires (threads) having a length is formed by using a single metal or an alloy metal.

When the single metal or the alloy metal is made into ultrafine wires, a resistance value of the ultrafine wire naturally increases.

Then, a plurality of the ultrafine wires are combined into a single bundle, thereby manufacturing a heating wire (heating element) having a length, which looks like one strand thread.

After that, when a current is applied to opposite ends of the wire, the wire instantaneously generates heat of super-high speed and super-high efficiency.

However, Since the heating element having a high resistance value can overcome the voltage drop by increasing the voltage and allow the current to flow to a long distance, to make a heating wire with a long length, the voltage has to be increased, and the higher the voltage, the greater the safety risk.

Thus, conventionally, there is a technical limitation in that a long heating wire or a long heating element having a long high resistance value for a low voltage cannot be made.

However, according to the present invention, by using the above described high-efficiency structure, it is possible to perform super-high speed and super-high temperature heating in a long heating wire (heating element) at a low voltage with super-high efficiency.

According to the first embodiment, the first and ninth problems of the background art can be solved.

### Embodiment 2

Embodiment 2 is a method in which a total combined resistance value of the plurality of ultrafine wires constituting the single bundle is changed to achieve a desired resistance value.

To be more specific to the embodiment 2, the heating wire (heating element) generates heat by the amount of current flowing therethrough and resistance value, so to manufacture a heating element with a predetermined amount of power (heating value), the amount of current required for the heating wire must flow, and assuming that the working voltage and heating wire length are predetermined, the heating wire resistance value must meet the given conditions so that the heating element can be manufactured.

For example, assuming that the amount of power (heating value) of the heating element to be made is 100 W, the working voltage is 10V, and the required length of the heating wire is 2 m, the current that can flow through this 2 m length-heating wire is 10 A and the resistance is 1Ω.

Herein, since the required length of the heating wire is 2 m, a resistance value should be 0.5Ω per 1 m length.

Further, assuming that the required length of the heating wire is 1 m by changing the condition, the heating wire should have a resistance value of 1Ω per 1 m length.

In these two cases, each resistance value of the heating wire must be customized to produce the required heating element in the field, but it is difficult to produce custom-made resistance value with conventional techniques.

The reason for this is that most of the conventional techniques simply adjust the resistance value by changing the cross-sectional area of the heating wire, and this method requires a lot of equipment, a complicated production process, and also it is virtually impossible to meet tens of thousands kinds of resistance values due to limitations of equipment technology.

However, according to the embodiment 2, it is possible to easily produce tens of thousands kinds of resistance values which cannot be achieved by the conventional technology.

That is, in the bundle (heating wire, heating element) of the embodiment 1, a customized heating element can be produced by adjusting the combined resistance value of the plurality of ultrafine wires in the bundle.

The formula to obtain the combined resistance value is the composite resistance value=1÷(1/R1+1/R2+1/R3 . . . ).

As described above, when the required resistance value of the heating wire is two kinds, 0.5Ω and 1Ω per 1 m, the method to adjust a combined resistance value is as follows:

First, 2-1 embodiment is a method in which the plurality of ultrafine wires are made of a same material and have a same thickness (a resistance value of each ultrafine wire is same), and the number of strands of the plurality of ultrafine wires is changed.

For example, assuming that a resistance value of one strand of the ultrafine wires is 10Ω, in order to make a combined resistance value of 1Ω, 10 strands of ultrafine wires should be combined.

That is, 1/R1=1/10Ω=0.1Ω, and 0.1×10 strands=1Ω, and then 1/1Ω, and thus a total combined resistance value becomes 1Ω.

Further, in order to make a combined resistance value of 0.5Ω, 20 strands of ultrafine wires should be combined.

That is, 1/R1=1/10Ω=0.1Ω, and 0.1×20 strands=2Ω, and then 1/2Ω, and thus a total combined resistance value becomes 0.5Ω.

Next, 2-2 embodiment is a method in which the plurality of ultrafine wires are made of a same material and a thickness of the plurality of ultrafine wires is changed and a thickness of the plurality of ultrafine wires is changed without changing the number of strands of the ultrafine wires.

For example, assuming that one strand of the first ultrafine wires has a thickness of 100 μm and a resistance value of 10Ω, and one strand of the second ultrafine wires has a thickness of 200 μm and a resistance value of 5Ω, in order to make a combined resistance value of 1Ω, 10 strands of the first ultrafine wires of 100 μm should be combined.

That is, 1/R1=1/10Ω=0.1Ω, and 0.1×10 strands=1Ω, and then 1/1Ω, and thus a total combined resistance value becomes 1Ω.

Further, in order to make a combined resistance value of 0.5Ω, 10 strands of the second ultrafine wires of 200 μm should be combined.

That is, 1/R1=1/5Ω=0.2Ω, and 0.2×10 strands=2Ω, and then 1/2Ω, and thus a total combined resistance value becomes 0.5Ω.

Next, 2-3 embodiment is a method in which the plurality of ultrafine wires have a same thickness and a same number of strands, and the material of the plurality of ultrafine wires is changed with two or more materials.

For example, assuming that 5 strands of ultrafine wire are made of material A, wherein a resistance value of one strand is 10Ω, and another 5 strands of ultrafine wire are made of material B, wherein a resistance value of one strand is 5Ω, in order to make a combined resistance value of 1Ω, 10 strands of ultrafine wire of material A should be combined.

That is, 1/R1=1/10Ω=0.1Ω, and 0.1×10 strands=1Ω, and then 1/1Ω, and thus a total combined resistance value becomes 1Ω.

Further, in order to make a combined resistance value of 0.5Ω, 10 strands of ultrafine wire of material B should be combined.

That is, 1/R1=1/5Ω=0.2Ω, and 0.2×10 strands=2Ω, and then 1/2Ω, and thus a total combined resistance value becomes 0.5Ω.

Next, 2-4 embodiment is a method in which the plurality of ultrafine wires have a same thickness and a same number of strands, a material of the plurality of ultrafine wires is different from group to group while making two or more groups with a same material, and the material of the ultrafine wire for each group is changed.

For example, assuming that first 5 strands of ultrafine wire are made of material A, wherein a resistance value of one strand is 10Ω, second 5 strands of ultrafine wire are made of material B, wherein a resistance value of one strand is 10Ω, third another 5 strands of ultrafine wire are made of material C, wherein a resistance value of one strand is 5Ω, and fourth 5 strands of ultrafine wire are made of material D, wherein a resistance value of one strand is 5Ω, in order to make a combined resistance value of 1Ω, ultrafine wires are constituted by 5 strands of the first group of material A, and 5 strands of the second group of material B, and should be combined.

That is, in the material A, 1/R1=1/10Ω=0.1Ω, and in the material B, 1/R1=1/10Ω=0.1Ω, and thus, the first group 0.1×5 strands=0.5Ω, and the second group 0.1×5 strands=0.5Ω. Accordingly, when the first and second groups are combined, a combined resistance value is 1Ω, and then 1/1Ω, and thus, a total combined resistance value becomes 1Ω.

Further, in order to make a combined resistance value of 0.5Ω, ultrafine wires are constituted by 5 strands of the first group of material C, and 5 strands of the second group of material D, and should be combined.

That is, in the material C, 1/R1=1/5Ω=0.2Ω, and in the material D, 1/R1=1/5Ω=0.2Ω, and thus, the first group 0.2×5 strands=1Ω, and the second group 0.2×5 strands=1Ω. Accordingly, when the first and second groups are combined, a combined resistance value is 2Ω, and then 1/2Ω, and thus a total combined resistance value becomes 0.5Ω.

Next, 2-5 embodiment is a method in which the plurality of ultrafine wires have a same thickness, a material of the ultrafine wire is different for each group while making two or more groups with a same material, and a number of strands of the ultrafine wires for each group is changed.

For example, assuming that 5 strands of ultrafine wire are made of material A, wherein a resistance value of one strand is 10Ω, and 10 strands of ultrafine wire are made of material E, wherein a resistance value of one strand is 20Ω, in order to make a combined resistance value of 1Ω, ultrafine wires are constituted by 5 strands of the first group of material A, and 10 strands of the second group of material E, and should be combined.

That is, in the material A, 1/R1=1/10Ω=0.1Ω, and in the material E, 1/R1=1/20Ω=0.055, and thus, the first group 0.1×5 strands=0.5Ω, and the second group 0.05×10 strands=0.5Ω. Accordingly, when the first and second groups are combined, a combined resistance value is 1Ω, and then 1/1Ω, and thus a total combined resistance value becomes 1Ω.

Further, in order to make a combined resistance value of 0.5Ω, ultrafine wires are constituted by 10 strands of the first group of material A, and 20 strands of the second group of material E, and should be combined.

That is, in the material A, 1/R1=1/10Ω=0.1Ω, and in the material E, 1/R 1=1/20Ω=0.05Ω, and thus, in the first group, 0.1×10 strand=1Ω, and in the second group, 0.05×20 strand=1Ω. Accordingly, when the first and second groups are combined, a combined resistance value is 2Ω, and then 1/2Ω, and thus, a total combined resistance value becomes 0.555.

Next, 2-6 embodiment is a method in which a material of the plurality of ultrafine wires is different from group to group while making two or more groups with a same material, and each group (material) or the bundle has a same number of strands while a thickness of each group (material) is changed.

For example, assuming that in A material group, one strand has a thickness of 100 μm and a resistance value of 10Ω, in B material group, one strand has a thickness of 200 μm and a resistance value of 10Ω, in C material group, one strand has a thickness of 100 μm and a resistance value of 5Ω, and in D material group, one strand has a thickness of 200 μm and a resistance value of 5Ω, in order to make a combined resistance value of 1Ω, ultrafine wires are constituted by 5 strands of the first group of material A, and 5 strands of the second group of material B, and should be combined.

That is, in the material A, 1/R1=1/10Ω=0.1Ω, and in the material B, 1/R1=1/10Ω=0.1Ω, and thus, the first group 0.1×5 strands=0.5Ω, and the second group 0.1×5 strands=0.5Ω. Accordingly, when the first and second groups are combined, a combined resistance value is 1Ω, and then 1/1Ω, and thus, a total combined resistance value becomes 1Ω.

Further, in order to make a combined resistance value of 0.5Ω, ultrafine wires are constituted by 5 strands of the first group of material C, and 5 strands of the second group of material D, and should be combined.

That is, in the material C, 1/R1=1/5Ω=0.2Ω, and in the material D, 1/R1=1/5Ω=0.2Ω, and thus, the first group 0.2×5 strands=1Ω, and the second group 0.2×5 strands=1Ω. Accordingly, when the first and second groups are combined, a combined resistance value is 2Ω, and then 1/2Ω, and thus a total combined resistance value becomes 0.5Ω.

Next, 2-7 embodiment is a method in which a material of the plurality of ultrafine wires is different from group to group while making two or more groups with a same material, and a thickness and a number of strands of each group (material) are changed.

Of the 2-7 embodiment, the most efficient two methods are as follows: \textcircled{a} method in which in the first group, a thickness and the number of strands of the ultrafine wires are changed, and in the second group, a material thereof is different from a material of the first group and a thickness and the number of strands thereof are same; and \textcircled{b} method in which in the first group, a thickness and a number of strands of the ultrafine wires are changed, and in the second group, a material thereof is different from a material of the first group and a thickness thereof is same and a number of strands thereof is changed.

To explain the method, it is assumed that, for example, in A material group, one strand with a thickness of 100 μm has a resistance value of 10Ω, and one strand with a thickness of 50 μm has a resistance value of 20Ω; in B material group, one strand with a thickness of 50 μm has a resistance value of 20Ω.

In this case, according to the first method, in order to make a combined resistance value of 1Ω, the thickness of the first group is changed in the first method, the number of strands is changed in the first method, and the second group is remained same, and 5 strands with a thickness of 100 μm of the first group (material A), and 10 strands with a thickness 50 μm of the second group (material B) are used and combined.

That is, in the material A with a thickness of 100 μm, 1/R1=1/10Ω=0.1Ω, and in the material B with a thickness of 50 μm, 1/R1=1/20Ω=0.055, and thus, in the first group, 0.1Ω×5 strand=0.5Ω, and in the second group, 0.05Ω×10 strand=0.5Ω. Accordingly, when the first and second groups are combined, a combined resistance value is 1Ω, and then 1/1Ω, and thus, a total combined resistance value becomes 1Ω.

According to the second method, in order to make a combined resistance value of 1Ω, the thickness of the first group is changed in the second method, the number of strands is changed in the second method, and the second group is remained same, 10 strands with a thickness of 50 μm of the first group (material A), and 10 strands with a thickness of 50 μm of the second group (material B) are used and combined.

That is, in the material A with a thickness of 50 μm, 1/R1=1/20Ω=0.055, and in the material B with a thickness of 50 μm, 1/R1=1/20Ω=0.055, and thus, in the first group, 0.05Ω×10 strands=0.5Ω, and in the second group, 0.05Ω×10 strands=0.5Ω. Accordingly, when the first and second groups are combined, a combined resistance value is 1Ω, and then 1/1Ω, and thus, a total combined resistance value becomes 1Ω.

Further, according to the first method, in order to make a combined resistance value of 0.5Ω, the thickness of the first group is changed in the first method, the number of strands is changed in the first method, and the second group is remained same, and 10 strands with a thickness of 100 μm of the first group (material A), and 20 strands with a thickness 50 μm of the second group (material B) are used and combined.

That is, in the material A with a thickness of 100 μm, 1/R1=1/10Ω=0.1Ω, and in the material B with a thickness of 50 μm, 1/R1=1/20Ω=0.05Ω, and thus, in the first group of 10 strands, 0.1Ω×10 strands=1Ω, and in the second group of 20 strands, 0.055×20 strands=1Ω. Accordingly, when the first and second groups are combined, a combined resistance value is 2Ω, and then 1/2Ω, and thus, a total combined resistance value becomes 0.5Ω.

According to the second method, in order to make a combined resistance value of 0.5Ω, the thickness of the first group is changed in the second method, the number of strands is changed in the second method, and the second group is remained same, 20 strands with a thickness of 50 μm of the first group (material A), and 20 strands with a thickness of 50 μm of the second group (material B) are used and combined.

That is, in the material A with a thickness of 50 μm, 1/R1=1/20Ω=0.05Ω, and in the material B with a thickness of 50 μm, 1/R1=1/20Ω=0.05Ω, and thus, in the first group of 20 strands, 0.05Ω×20 strands=1Ω, and in the second group of 20 strands, 0.05Ω×20 strands=1Ω. Accordingly, when the first and second groups are combined, a combined resistance value is 2Ω, and then 1/2Ω, and thus, a total combined resistance value becomes 0.5Ω.

To explain the \textcircled{b} method, it is assumed that, for example, in A material group, one strand with a thickness of 100 μm has a resistance value of 10Ω, and one strand with a thickness of 50 μm has a resistance value of 20Ω; in B material group, one strand with a thickness of 50 μm has a resistance value of 20Ω, and one strand with a thickness of 25 μm has a resistance value of 40Ω.

In this case, in order to make a combined resistance value of 1Ω, the first method and the second method are the same as in the \textcircled{a} method.

Further, according to the first method, in order to make a combined resistance value of 0.5Ω, as in the method of making a combined resistance value of 1Ω (the first group made of the same material, and the number of strands and the thickness thereof changed), the first group has the same number of strands and the same thickness; and as in the method of making a combined resistance value of 1Ω, in the second group, the number of strands thereof is changed while having the same thickness.

In other words, as in making a combined resistance value of 1Ω in the first method, the first group (material A) is constituted by 5 strands with a thickness of 100 μm, and as in making a combined resistance value of 1Ω in the first method, the second group (material B) has the same thickness of 50 μm, and the number of strands is changed to 30 strands, and these two groups are combined.

That is, in the material A with a thickness of 100 μm, 1/R1=1/10Ω=0.1Ω, and in the material B with a thickness of 50 μm, 1/R1=1/20Ω=0.055, and thus, in the first group of 5 strands with a thickness of 100 μm, 0.1Ω×5 strands=0.5Ω, and in the second group of 30 strands with a thickness of 50 μm, 0.055×30 strands=1.5Ω. Accordingly, when the first and second groups are combined, a combined resistance value is 2Ω, and then 1/2Ω, and thus, a total combined resistance value becomes 0.5Ω.

According to the second method, in order to make a combined resistance value of 0.5Ω, as in the method of making a combined resistance value of 1Ω, the first group has the same number of strands and the same thickness, and as in the method of making a combined resistance value of 1Ω, the number of strands is changed in the second method, with the same thickness.

In other words, as in making a combined resistance value of 1Ω in the second method, the first group (material A) is constituted by 10 strands with a thickness of 50 μm, and as in making a combined resistance value of 1Ω in the second method, the second group (material B) has the same thickness of 50 μm, and the number of strands is changed to 30 strands, and these two groups are combined.

That is, in the material A with a thickness of 50 μm, 1/R1=1/20Ω=0.05Ω, and in the material B with a thickness of 50 μm, 1/R1=1/20Ω=0.05Ω, and thus, in the first group of 10 strands with a thickness of 50 μm, 0.055×10 strands=0.5Ω, and in the second group of 10 strands with a thickness of 50 μm, 0.055×30 strands=1.5Ω. Accordingly, when the first and second groups are combined, a combined resistance value is 2Ω, and then 1/2Ω, and thus, a total combined resistance value becomes 0.5Ω.

Further, according to the first method, in order to make a combined resistance value of 0.25Ω, as in the method of making a combined resistance value of 1Ω, the first group has the same number of strands and the same thickness; and as in the method of making a combined resistance value of 1Ω, in the second group, the number of strands thereof is changed while having the same thickness.

In other words, as in making a combined resistance value of 1Ω in the first method, the first group (material A) is constituted by 5 strands with a thickness of 100 μm, and as in making a combined resistance value of 1Ω in the first method, the second group (material B) has the same thickness of 50 μm, and the number of strands is changed to 70 strands, and these two groups are combined.

That is, in the material A with a thickness of 100 μm, 1/R1=1/10Ω=0.1Ω, and in the material B with a thickness of 50 μm, 1/R1=1/20Ω=0.05Ω, and thus, in the first group of 5 strands with a thickness of 100 μm, 0.1Ω×5 strands=0.5Ω, and in the second group of 70 strands with a thickness of 50 μm, 0.055×70 strands=3.5Ω. Accordingly, when the first and second groups are combined, a combined resistance value is 4Ω, and then 1/4Ω, and thus, a total combined resistance value becomes 0.25Ω.

According to the second method, in order to make a combined resistance value of 0.2Ω, as in the method of making a combined resistance value of 1Ω, the first group has the same number of strands and the same thickness, and as in the method of making a combined resistance value of 1Ω, the number of strands is changed in the second method, with the same thickness.

In other words, as in making a combined resistance value of 1Ω in the second method, the first group (material A) is constituted by 10 strands with a thickness of 50 μm, and as in making a combined resistance value of 1Ω in the second method, the second group (material B) has the same thickness of 50 μm, and the number of strands is changed to 70 strands, and these two groups are combined.

That is, in the material A with a thickness of 50 μm, 1/R1=1/20Ω=0.05Ω, and in the material B with a thickness of 50 μm, 1/R1=1/20Ω=0.05Ω, and thus, in the first group of 10 strands with a thickness of 50 μm, 0.05Ω×10 strands=0.5Ω, and in the second group of 70 strands with a thickness of 50 μm, 0.05Ω×70 strands=3.5Ω. Accordingly, when the first and second groups are combined, a combined resistance value is 4Ω, and then 1/4Ω, and thus, a total combined resistance value becomes 0.255.

Further, 2-8 embodiment is a method in which a total combined resistance value is changed in a method by combining all of the above described the 2-1 to 2-7 embodiments or selectively combining the same, thereby achieving a customized resistance value.

Of these various embodiments, two practical and effective methods are the \textcircled{a} method and the \textcircled{b} method of the 2-7 embodiment, and the most suitable method among them is the \textcircled{b} method.

The heating element made by a method of customizing the desired resistance value by changing the combined resistance value as described above will now be described as follows.

Assuming that a heating element with a small area is to be made, there is a place only for heating wire (heating element) of 1 m in length, and a required resistance value per 1 m of heating wire is 1Ω, 2Ω, and 3Ω, manufacturing of heating element by using these is as follows:

as the first method,

\textcircled{1} the heating element is made by using a method of making a resistance value per length as about 1Ω per 1 m length of a bundle, and the ultrafine wires made of same material of the two materials have a same thickness, and ultrafine wires of one material have a thickness and a number of strands different from a thickness and a number of strands of ultrafine wires of the other material:

a. One material of the two materials is SUS 316 of stainless steel with one strand of ultrafine wire having a thickness of 12 μm and a number of strands being 550, the other material of the two materials is nickel-copper alloy metal containing from 20 to 25% by weight of nickel and the remaining of copper (from 75 to 80% by weight), with one strand of ultrafine wire having a thickness of 100 μm (a resistance value of about 36Ω per strand) and a number of strands being 24, and the two materials are bundled into one such that a resistance value per 1 m length of heating wire is about 1Ω, whereby a uniform resistance value is achieved along an entire length of a heating element.

b. One material of the two materials is SUS 316 of stainless steel with one strand of ultrafine wire having a thickness of 8 μm and a number of strands being 1,000, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 24, and the two materials are bundled into one such that a resistance value per 1 m length of heating wire is about 1Ω, whereby a uniform resistance value is achieved along an entire length of a heating element.

c. One material of the two materials is SUS 316 of stainless steel with one strand of ultrafine wire having a thickness of 6.5 μm and a number of strands being 2,000, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 24, and the two materials are bundled into one such that a resistance value per 1 m length of heating wire is about 1Ω, whereby a uniform resistance value is achieved along an entire length of a heating element.

d. One material of the two materials is SUS 316 of stainless steel with one strand of ultrafine wire having a thickness of 100 μm and a number of strands being 40, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 24, and the two materials are bundled into one such that a resistance value per 1 m length of heating wire is about 1Ω, whereby a uniform resistance value is achieved along an entire length of a heating element.

\textcircled{2} the heating element is made by using a method of making a resistance value per length as about 2Ω per 1 m length of a bundle, and the ultrafine wires made of same material of the two materials have a same thickness, and ultrafine wires of one material have a thickness and a number of strands different from a thickness and a number of strands of ultrafine wires of the other material:

a. One material of the two materials is SUS 316 of stainless steel with one strand of ultrafine wire having a thickness of 12 μm and a number of strands being 550, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 14, and the two materials are bundled into one such that a resistance value per 1 m length of heating wire is about 2Ω, whereby a uniform resistance value is achieved along an entire length of a heating element.

b. One material of the two materials is SUS 316 of stainless steel with one strand of ultrafine wire having a thickness of 8 μm and a number of strands being 1000, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 14, and the two materials are bundled into one such that a resistance value per 1 m length of heating wire is about 2Ω, whereby a uniform resistance value is achieved along an entire length of a heating element.

c. One material of the two materials is SUS 316 of stainless steel with one strand of ultrafine wire having a thickness of 6.5 μm and a number of strands being 2000, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 14, and the two materials are bundled into one such that a resistance value per 1 m length of heating wire is about 2Ω, whereby a uniform resistance value is achieved along an entire length of a heating element.

d. One material of the two materials is SUS 316 of stainless steel with one strand of ultrafine wire having a thickness of 100 μm and a number of strands being 40, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 14, and the two materials are bundled into one such that a resistance value per 1 m length of heating wire is about 2Ω, whereby a uniform resistance value is achieved along an entire length of a heating element.

\textcircled{3} the heating element is made by using a method of making a resistance value per length as about 3Ω per 1 m length of a bundle, and the ultrafine wires made of same material of the two materials have a same thickness, and ultrafine wires of one material have a thickness and a number of strands different from a thickness and a number of strands of ultrafine wires of the other material,

a. One material of the two materials is SUS 316 of stainless steel with one strand of ultrafine wire having a thickness of 12 μm and a number of strands being 550, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 9, and the two materials are bundled into one such that a resistance value per 1 m length of heating wire is about 3Ω, whereby a uniform resistance value is achieved along an entire length of a heating element.

b. One material of the two materials is SUS 316 of stainless steel with one strand of ultrafine wire having a thickness of 12 μm and a number of strands being 1000, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 9, and the two materials are bundled into one such that a resistance value per 1 m length of heating wire is about 3Ω, whereby a uniform resistance value is achieved along an entire length of a heating element.

c. One material of the two materials is SUS 316 of stainless steel with one strand of ultrafine wire having a thickness of 6.5 μm and a number of strands being 2000, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 9, and the two materials are bundled into one such that a resistance value per 1 m length of heating wire is about 3Ω, whereby a uniform resistance value is achieved along an entire length of a heating element.

d. One material of the two materials is SUS 316 of stainless steel with one strand of ultrafine wire having a thickness of 100 μm and a number of strands being 40, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 9, and the two materials are bundled into one such that a resistance value per 1 m length of heating wire is about 3Ω, whereby a uniform resistance value is achieved along an entire length of a heating element.

Next, in the second method, NASLON (steel fiber or metal fiber) with the same thickness and the same number of strands is used instead of manufacturing ultrafine wire by using SUS 316 material as one kind ultrafine wire in the first method, wherein of the steel fibers (NASLONs), there are already ready-made products, so it is possible to select one of them and substitute the same specification.

According to the second embodiment, the second problem of the background art can be solved.

### Embodiment 3

Embodiment 3 uses a heating element with a uniform resistance value along an entire length thereof achieved in the embodiments 1 and 2.

To make the bundle (heating element) of the embodiments 1 and 2 have uniform resistance value along the entire length thereof, of all of a plurality of ultrafine wires in the bundle, ultrafine wires where a length of each ultrafine wire is the same and the ultrafine wire has a uniform resistance value should be used from the beginning.

For each ultrafine wire, as a method of making an entire length thereof same and ensuring a uniform resistance value, first, there is a method in which a metal filament microfiber made of a single metal or an alloy metal through a precision drawing machine (a wire drawing machine) is used as the ultrafine wire,

second, there is a method in which a metal spun microfiber made of a single metal or an alloy metal through a precision spinning machine is used as the ultrafine wire, and

third, there is a method in which a steel fiber (NASLON) is used as the ultrafine wire.

In the first method, a method of making the metal filament microfiber through the drawing machine (the wire drawing machine) may be a drawing method.

After each ultrafine wire has a uniform resistance value in its entire length through these three methods, when the ultrafine wires are bundled, a uniform resistance value is achieved along the entire length of a heating element in all of the bundle (heating element) of the embodiments 1 and 2, it is possible to improve electrical safety.

According to the third embodiment, the third problem of the background art can be solved.

### Embodiment 4

Embodiment 4 is a method in which a plurality of ultrafine wires constituting a bundle (heating wire, heating element) of the embodiments 1 to 3 are grouped into groups with different functions, wherein one group functions to continuously generate heat when current flows, and another group generates less heat after reaching a predetermined temperature and functions to allow the current to flow like a conductor rather than generating heat as becoming conductive, and these two ultrafine wire groups are combined to be bundled into one strand.

The only way to maintain the constant temperature (predetermined temperature) in the material itself without a separate thermostat is to use the PTC principle.

The PTC temperature control method is the principle of keeping the temperature within a certain range by repeating the operation of automatically dropping the temperature when the heating wire is heated and the temperature rises, the conductive molecule interval is widened and the resistance value is increased to automatically reduce the value of current flowing through the heating wire. However, this principle has a technical limitation in that it cannot raise the heating temperature of the heating wire to high temperature only by keeping the temperature of the heating element at a low temperature.

Accordingly, it is not suitable where the high temperature heat is required in the actual field, and in particular, it cannot perform the function of embodiment 5 described below at all.

Thus, the present invention proposes a method of maintaining a constant temperature in a heating wire (heating element) material itself other than the PTC principle, whereby it can maintain the constant temperature in high temperature and super-high temperature ranges as well as in a low temperature range while being high-efficiency.

When the heating wire generates heat, by the equation (Q=0.24×I2×R×T), heat is generated in proportion to the heating time, and the generated heat is transferred to the outside (heat is lost) while being heated, and the temperature is.

However, if the amount of heat generated in the heating wire is greater than the amount of heat loss, the heating wire temperature is continuously increased, if it is less than the amount of heat loss, the heating wire temperature is dropped, and if it is equal to the amount of heat loss, the heating wire temperature is maintained at a constant temperature.

In the present invention, on the basis of this principle, the equilibrium state of the quantity of heat generated in the heating wire and the quantity of heat to be lost is effectively accomplished in a short time, and this action is automatically performed by the material itself, thereby achieving the purpose of maintaining a constant temperature.

That is, in the present invention, the heating wire is constituted by a plurality of ultrafine wires, wherein the plurality of ultrafine wires are grouped into groups with different functions, wherein one group functions to continuously generate heat when current flows, and another group generates less heat after reaching a predetermined temperature and functions to allow the current to flow like a conductor rather than generating heat as becoming conductive, and these two ultrafine wire groups are combined to be bundled into one strand.

When the current is applied to the heating wire, all of the first and second groups generate heat to raise temperature rapidly at a predetermined temperature, and then, the second group stops the heat generation and turns into a conductor and allows the current to flow away at a predetermined temperature range.

The temperature rising speed of the heating wire decreases from this point, and from a certain temperature range, the quantity of heating and the quantity of heat loss by the surrounding are equal to each other at a constant temperature, and the constant temperature (predetermined temperature) is maintained as long as the condition of taking away the quantity of heat is not changed.

Further, if it is possible to make this constant temperature maintenance function more customizable, that is, if the heating wire is produced in a customized manner to remain constant at any desired temperature range in the required location, the heating wire can be applied widely.

A method of customizing is configured in such a way that after a bundle (heating wire, heating element) with basic function is prepared, experiments are conducted to set a reference value by determining the fastest thermal equilibrium at each specific temperature range (while adjusting the value of current flowing in the bundle, the thickness of the bundle, the resistance value of the bundle, the ultrafine wire number of strands used in the bundle, the ultrafine wire material, and the number of ultrafine wire types, and the like), and based on the experimental data, it is possible to customize case by case by adjusting the ratio of ultrafine wire thickness, material, and number of strands in the first group and the second group.

For example, experimental results show that there are two groups of ultrafine wire in one bundle, wherein in one group, 3 strands of A material are used, and the ultrafine wire is assumed to generate 10° C. heat per strand when a current of 1 A flows per second per strand, and in the other group, 7 strands of B material, and the ultrafine wire is assumed to generate 10° C. heat per strand when a current of 1 A flows per second per strand to a temperature of 100° C., and generate only 1° C. per second after reaching 100° C.,

When a current of 10 A per second is applied to the bundle, assuming that no heat is lost to the outside, after one second, the temperature will reach 100° C., after which the temperature will increase by 37° C. per second.

However, assuming that there is an environment in which heat is taken away from the outside by 37° C. per second and this heating wire is used in that environment, The heating wire initially rises by 63° C. per second, and after reaching 100° C. before 2 seconds passes, the thermal equilibrium is established and the constant temperature of 100° C. is maintained.

The method of making a bundle (heating element) with a custom resistance value is the same as that described in embodiment 2.

That is, the resistance value of the bundle is customized such that a current of 10 A flows per second. To achieve this, firstly, the length of the heating wire required in the environmental field is determined, and the working voltage is determined, and then it can be manufactured by specifying the required resistance value by customizing method of resistance value.

Here, a method of determining the required resistance value as follows: For example, a space of the greenhouse which has a large space for cultivating the crops is to be heated, assuming that the space is wanted to be heated by laying a line of bundle (heating wire) that keeps the temperature of 100° C. without a separate control function for each furrow that has a length of 22 m, and the environment in this greenhouse has an environment that takes away heat from the heating wire by 37° C. per second.

Here, resistance is 220V÷10 A=22Ω, and a length of a required heating wire to be used is 22 m, so the bundle is customized into a bundle (heating wire) having a resistance value of 1ω per meter by the method of customizing resistance value in embodiment 2, and then the bundle is cut by 22 m to make units, and multiple units are used by being connected in parallel with each other at the site.

Then, all of the bundles (heating wire, heating element) installed at the site are maintained at the temperature of 100° C. at the same time, and the heating wire alone maintains the constant temperature without providing a separate.

Taking as an example how to customize the constant temperature function, the method follows the 2-4 embodiment to the 2-8 embodiment of the embodiment 2.

Further, an example of a heating element made by a custom-made method for such a constant temperature function follows the first method 2 and the second method of the embodiment 2.

According to the embodiment 4, the fourth problem of the background art can be solved.

### Embodiment 5

Embodiment 5 is a method of combining a plurality of ultrafine wires into one body and bundling the same into a single-strand heating wire (heating wire).

If a plurality of ultrafine wires in the bundle according to the embodiments 1 to 4 are not in contact with each other like one body, as the distance between the ultrafine wire and the ultrafine wire increases, a potential difference occurs and a reverse current or bias current drift occurs, causing overheating, which may lead ultrafine wire damage or fire.

Accordingly, through a method of joining multiple strands of ultrafine wire together (bundling method), the entire strands should be formed into a heating wire (heating element) having a length, which is in a shape of one-strand thread.

As a bundling method, firstly, a plurality of ultrafine wires are combined and a high temperature thread (fiber) is wrapped around the ultrafine wires such that the high temperature thread (fiber) forms a cover to combining a plurality of ultrafine wires thereinside, which looks like one strand thread.

Here, a material of the high temperature fiber may be a thread made of aramid, polyarylate, or zylon (PBO fiber).

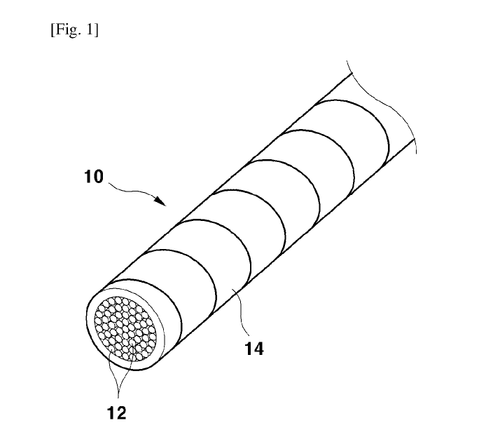

FIG. 1 is a view showing a heating wire (heating element) 10 manufactured by a first bundling method, wherein a plurality of ultrafine wires 12 joined together is wrapped with a high temperature fiber 14 along a length direction thereof to form a cover.

Second, a plurality of ultrafine wires are bundled into one body by twisting the same through a double twister.

Third, a plurality of ultrafine wires are bundled by drawing and coating the same after putting the same into a coating machine.

Here, a coating material may be Teflon, PVC, or silicone.

Fourth, a plurality of ultrafine wires are bundled by disposing the same between upper and lower plates of planar material, putting an adhesive thereinto, and melting the adhesive.

Here, the planar material may be a PET plate, plain fabric, or a tin plate.

Further, the adhesive may be a TPU liquid, a TPU plate, a silicone liquid, a silicone plate, a hot-melt liquid, or a hot-melt plate.

Further, melting of the adhesive may be performed by thermal compression using a hot press such that the internal ultrafine wire is impregnated and immobilized while melting the adhesive or may be performed by a high frequency using a high frequency device or a compressor such that the internal ultrafine wire is impregnated and immobilized while melting and pressing the adhesive.

Fifth, a plurality of ultrafine wires are bundled by combining the above four methods.

For example, the bundle produced by the first or second method is coated more than twice (coating the once-coated bundle again) in the third method.

### Embodiment 6

Embodiment 6 is a method in which a wire connection is implemented to allow current to flow through a heating element (heating wire) manufactured by the above described embodiments 1 to 5. Since the heating element according to the embodiments of the present invention is constituted by a plurality of ultrafine wires, unless all of the multiple strands are connected to a wire, current may not flow through a portion of the unconnected ultrafine wire or unevenness of a resistance value may be caused, resulting in local overheating.

Accordingly, a plurality of ultrafine wires must be connected in such a way that a plurality of ultrafine wires are simultaneously connected to the power supply line (wire).

One of methods of embodiment 6 is as follows: opposite ends of the bundle (heating element or heating wire) are inserted into a connection terminal or a sleeve and simultaneously, a stripped part of a wire is inserted into the sleeve to be overlapped with a plurality of ultrafine wires, and when the connection terminal (sleeve) is pressed, the wire and a plurality of ultrafine wires are connected to each other, thereby forming a structure that allows current to flow simultaneously through all of the ultrafine wires.

### Embodiment 7

A special material to be used as ultrafine wire materials of all bundles according to the above described embodiments is required to solve the first to eighth problems of the background art, and can solve a problem of snapping easily due to no flexibility and weak tensile force, and a problem of short service life by being easily hardened and breaking easily due to weak durability and strong oxidizing of the ninth problem, simultaneously.

In the embodiment 7, as a special material for ultrafine wire, first, stainless steel type alloys are usually preferred, especially SUS 316 is the most effective, and the finer it is, the more the effect it is.

Second, as a steel fiber (NASLON) that meets the same function as SUS 316, a ready-made steel fiber may be used.

Third, a special alloy performing the above function may be made by oneself, wherein a nickel-copper alloy is used, which contains from 20 to 25% by weight of nickel and from 75 to 80% by weight of copper.

Further, an alloy of iron, chromium, alumina and molybdenum is used, and the mixing ratio thereof is from 65 to 75% by weight of iron, from 18 to 22% by weight of chromium, from 5 to 6% by weight of alumina, and the remaining ratio of molybdenum, and it is also possible to use alloy metal made by adding the alloy with small amounts of silicone, manganese and carbon.

Fourth, mixture of the first to third materials may be used.

For example, ultrafine wires constituting the bundle (heating wire, heating element) manufactured in the embodiments 1 to 6 are grouped into two groups, wherein the first material or second material of stainless steel type material must be used for one group, and the third material of nickel-copper alloy may be used for the other group.

According to the embodiment 7, the ninth problem of the background art can be solved.

### Embodiment 8

Examples of the heating element manufactured by embodiments 1 to 7 are as follows.

When a required resistance value per 1 m of heating wire is 1Ω, 2Ω, and 3Ω in the actual field, manufacturing of heating element by using these is as follows,

as the first method,

\textcircled{1} the heating element is made by using a method of making a resistance value per length as about 1Ω per 1 m length of a bundle, and the ultrafine wires made of same material of the two materials have a same thickness, and ultrafine wires of one material have a thickness and a number of strands different from a thickness and a number of strands of ultrafine wires of the other material:

a. One material of the two materials is SUS 316 of stainless steel with one strand of ultrafine wire having a thickness of 12 μm and a number of strands being 550, the other material of the two materials is nickel-copper alloy metal containing from 20 to 25% by weight of nickel and the remaining of copper (from 75 to 80% by weight), with one strand of ultrafine wire having a thickness of 100 μm (a resistance value of about 36Ω per strand) and a number of strands being 24, and the two materials are bundled into one such that a resistance value per 1 m length of heating wire is about 1Ω, whereby a uniform resistance value is achieved along an entire length of a heating element.

b. One material of the two materials is SUS 316 of stainless steel with one strand of ultrafine wire having a thickness of 8 μm and a number of strands being 1,000, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 24, and the two materials are bundled into one such that a resistance value per 1 m length of heating wire is about 1Ω, whereby a uniform resistance value is achieved along an entire length of a heating element.

c. One material of the two materials is SUS 316 of stainless steel with one strand of ultrafine wire having a thickness of 6.5 μm and a number of strands being 2,000, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 24, and the two materials are bundled into one such that a resistance value per 1 m length of heating wire is about 1Ω, whereby a uniform resistance value is achieved along an entire length of a heating element.

d. One material of the two materials is SUS 316 of stainless steel with one strand of ultrafine wire having a thickness of 100 μm and a number of strands being 40, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 24, and the two materials are bundled into one such that a resistance value per 1 m length of heating wire is about 1Ω, whereby a uniform resistance value is achieved along an entire length of a heating element.

\textcircled{2} the heating element is made by using a method of making a resistance value per length as about 2Ω per 1 m length of a bundle, and the ultrafine wires made of same material of the two materials have a same thickness, and ultrafine wires of one material have a thickness and a number of strands different from a thickness and a number of strands of ultrafine wires of the other material:

a. One material of the two materials is SUS 316 of stainless steel with one strand of ultrafine wire having a thickness of 12 μm and a number of strands being 550, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 14, and the two materials are bundled into one such that a resistance value per 1 m length of heating wire is about 2Ω, whereby a uniform resistance value is achieved along an entire length of a heating element.

b. One material of the two materials is SUS 316 of stainless steel with one strand of ultrafine wire having a thickness of 8 μm and a number of strands being 1000, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 14, and the two materials are bundled into one such that a resistance value per 1 m length of heating wire is about 2Ω, whereby a uniform resistance value is achieved along an entire length of a heating element.

c. One material of the two materials is SUS 316 of stainless steel with one strand of ultrafine wire having a thickness of 6.5 μm and a number of strands being 2000, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 14, and the two materials are bundled into one such that a resistance value per 1 m length of heating wire is about 2Ω, whereby a uniform resistance value is achieved along an entire length of a heating element.

d. One material of the two materials is SUS 316 of stainless steel with one strand of ultrafine wire having a thickness of 100 μm and a number of strands being 40, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 14, and the two materials are bundled into one such that a resistance value per 1 m length of heating wire is about 2Ω, whereby a uniform resistance value is achieved along an entire length of a heating element.

\textcircled{3} the heating element is made by using a method of making a resistance value per length as about 3Ω per 1 m length of a bundle, and the ultrafine wires made of same material of the two materials have a same thickness, and ultrafine wires of one material have a thickness and a number of strands different from a thickness and a number of strands of ultrafine wires of the other material:

a. One material of the two materials is SUS 316 of stainless steel with one strand of ultrafine wire having a thickness of 12 μm and a number of strands being 550, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 9, and the two materials are bundled into one such that a resistance value per 1 m length of heating wire is about 3Ω, whereby a uniform resistance value is achieved along an entire length of a heating element.

b. One material of the two materials is SUS 316 of stainless steel with one strand of ultrafine wire having a thickness of 8 μm and a number of strands being 1000, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 9, and the two materials are bundled into one such that a resistance value per 1 m length of heating wire is about 3Ω, whereby a uniform resistance value is achieved along an entire length of a heating element.

c. One material of the two materials is SUS 316 of stainless steel with one strand of ultrafine wire having a thickness of 6.5 μm and a number of strands being 2000, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 9, and the two materials are bundled into one such that a resistance value per 1 m length of heating wire is about 3Ω, whereby a uniform resistance value is achieved along an entire length of a heating element.

d. One material of the two materials is SUS 316 of stainless steel with one strand of ultrafine wire having a thickness of 100 μm and a number of strands being 40, the other material of the two materials is nickel-copper single metal containing from 20 to 25% by weight of nickel and the remaining of copper, with one strand of ultrafine wire having a thickness of 100 μm (a resistance value of about 36Ω per strand) and a number of strands being 9, and the two materials are bundled into one such that a resistance value per 1 m length of heating wire is about 3Ω, whereby a uniform resistance value is achieved along an entire length of a heating element.

Next, in the second method, NASLON (steel fiber or metal fiber) with the same thickness and the same number of strands is used instead of manufacturing ultrafine wire by using SUS 316 material as one kind ultrafine wire in the first method, wherein of the steel fibers (NASLONs), there are already ready-made products, so it is possible to select one of them and substitute the same specification.

### Embodiment 9

It would be better if the heating element could be used in a practical way in a versatile manner by using the method of embodiments 1 to 8, and that this heating element could realize various advanced functions.

For example, the advanced functions that the heating element can perform are as follows: First, high-temperature heating above 100° C. enables to radiate a large amount of far infrared rays with a long distance and to heat a wide space. At the same time, it can realize advanced function to make uniform heating in the entire wide space.

Here, especially when used for heating in agricultural houses (greenhouses), it gives far infrared rays to the crops, which causes various beneficial actions (increased crop yield).

Second, it generates heat with low voltage (especially below 24V), and particularly, generates high temperature heat with low voltage, so it can be used versatile in high-tech fields.

Here, it can be used for all kinds of heating such as space heating, building indoor heating, floor heating, etc. with low voltage with safety (no harmful electromagnetic waves when using DC), and it is possible to highly efficiently and safely boil water with low voltage.

It can be used for numerous functions and applications in many fields.

A method for manufacturing a heating element with advanced functions and applications and a heating element manufactured thereby are as follows,

\textcircled{1} First, the heating element manufactured by the above described embodiments 1 to 8 may be used in such a way that after the heating element is manufactured by adjusting a temperature of the heating element itself to a temperature range required in a field, the heating element is cut into a predetermined length to make units, with one unit being one circuit, and multiple circuits of the units are used by being connected in parallel with each other.

Of these methods, in customizing a heating element by adjusting a required temperature range, there is a method of changing the value of current flowing in the heating element to adjust the target heating temperature, and in particular, it is possible to manufacture a heating element that generates heat of over 100° C. by flowing over the value of current of 3 A.

\textcircled{2} Second, the heating element manufactured by the above described embodiments 1 to 8 may be used in such a way that after the heating element is manufactured to be operated (reducing a resistance value) in a desired low voltage range (for example, 50V or less), the heating element is cut into a predetermined length to make units, with one unit being one circuit, and multiple circuits of the units are connected in parallel with each other and are used by being connected to a low voltage power supply supplying low voltage power.

Herein, a method of adjusting a desired low voltage may be performed by adjusting a resistance value per unit length of the heating element, and a method of lowering a resistance value per unit length may be configured in such a way that the heating element has a 10Ω per 1 m length.

Further, as the low voltage power supply, a low voltage AC transformer, a low voltage DC adapter, a storage battery, an energy storage system (ESS), a photovoltaic module (solar cell panel), or equipment with a photovoltaic module (solar cell panel) connected to a storage battery or an ESS may be used.

Further, the low voltage range may be AC 24V or less, or is DC 24V or less.

\textcircled{3} Third, by combining the first and second methods, there is a method to generate high temperature (100° C. or more) heat with low voltage (50V or less).

\textcircled{4} Fourth, the heating element manufactured by the first to third methods is inserted into or attached to a fixture to be fixed.

\textcircled{5} Fifth, the heating element (heating wire) manufactured by the first to third methods is coated with a special coating.

After coating the heating element, the coated heating element may be covered with a shielding shield, and then may be coated with a coating again.

Hereinafter, description will be made to technical implementations of the five methods for manufacturing a heating element according to above described embodiment 9.

<Implementation 1>

Firstly, according to the first method (implementation 1), it is possible to uniformly heat a large space.

In order to uniformly heat a large space by using a heating element, the heating element should be made of material that emitting a large amount of far infrared rays when heat is applied and have a structure capable of letting the generated far infrared rays fly.

High temperature of 100° C. to 1,000° C. is applied to the heating element at a super-high speed, the generated far infrared rays have a continuous high temperature and fly over a long distance (flying distance), spread evenly over a large space, and cause resonance to generate a high temperature.

To be more specific, the reason why the heating element cannot be used to heat a large space and the reason why it fails to uniformly heat until now is that there is a limit to the transfer of heat to a large space because the heat transfer method of the heating equipment, such as a heater, a heat fan, and a radiator, is the conduction or the convection method.

To solve this problem, the heat source must be far infrared rays.

The far infrared rays transfer heat as radiant heat, which can simultaneously heat the whole space and allow uniform heating in a large space.

Accordingly, if heating is performed using far infrared rays, all the problems are solved. However, most of the electric heating wires and heating elements developed so far are not the way to generate far infrared rays.

Further, to generate far infrared rays, a heating wire (heating element) material is important.

It is not possible to generate far infrared rays with general metals or general single metals.

The heating wire (heating element) having far-infrared rays emission function developed recently is made of a carbon. However, in this heating wire, far infrared rays cannot fly away and can only be blown out between 30 to 80 cm, and its effect is very insufficient, so it is less practical than ordinary conduction or convection heater.

As described above, in order for far infrared rays emitted from an electric heating wire to be practical, far infrared rays must fly over a long distance (flying distance), and to fly a long distance sufficient to fill a large space, it is necessary to maintain a high temperature above a predetermined temperature on the material that generates far infrared rays when heat is applied. Here, the higher the temperature, the more effective it is. In addition to that, far infrared rays should be produced more efficiently, and the long flying distance effect is only achieved when the structure becomes capable of flying.

That is, the best way to achieve uniform heating in a large space is to make the heating wire (heating element) keep the heating temperature at least 100° C. to 1000° C. by making the material that generates far infrared rays when heat is applied, and to have a structure capable of generating more far infrared rays with better efficiency when high temperature heat is simultaneously generated.

The heating wire (heating element) generates far infrared rays with a long flying distance only when the heating wire (heating element) with the above structure is supplied with electricity to generate heat, so that the space heating and the uniform heating can be performed by radiant heat.

A specific method of making a heating wire (heating element) satisfying all of these is as follows:

Firstly, as a first condition, a material should emit a large amount of far infrared rays when heat is applied, and the materials should be capable of withstanding high temperature heat from 100° C. to 1000° C. for a long period of time. As a material satisfying all of these conditions, the material presented in the embodiment 7 may be used.

Next, as a second condition, a heating element should have a structure capable of generating more far infrared rays with better efficiency when high temperature heat is simultaneously generated. The heating element manufactured by the embodiments 1 to 7 has a structure realizing this function (effect).

That is because, a material emitting a large amount of far infrared rays having a long flying distance when exposed to high temperature, is made into extremely thin ultrafine wires, so that the far infrared rays are emitted from inside the heating wire to outside the ultrafine wire (If the cross-sectional area of the heating wire is large, even if the far infrared rays are generated in the heating wire, the probability of being held in the heating wire itself is increased,). Further, since far infrared rays are allowed to easily hold a high temperature (the heating element of the present invention allowing super-high speed and super-high temperature heating), thereby increasing the oscillation amplitude of atomic motion so far infrared rays can fly far away.

Next, as a third condition, the heating element satisfying the first condition and the second condition should generate high temperature heat of 100° C. to 1,000° C. To achieve this high temperature heating, a method for manufacturing a heating element is as follows:

As described above, a use method of the heating element manufactured by the embodiments 1 to 8 is configured in such a way that after the heating element is manufactured by adjusting a temperature of the heating element itself to a temperature range required in a field, the heating element is cut into a predetermined length to make units, with one unit being one circuit, and multiple circuits of the units are used by being connected in parallel with each other.

Of these methods, in customizing a heating element by adjusting a required temperature range, there is a method of changing the value of current flowing in the heating element to adjust the target heating temperature, and in particular, it is possible to manufacture a heating element that generates heat of over 100° C. by flowing over the value of current of 3 A.

To be more specific, if the heating element's temperature is wanted to be more than 150° C. by using 220V voltage, firstly, after 220V voltage is connected to the heating element manufactured by the embodiments 1 to 8 while satisfying the first condition and the second condition, the current is flowed to measure the heating temperature while adjusting a resistance value, and a value of current at the time of sustained heating at 150° C. is measured.

Next, a required length of the heating wire at the site is determined.

Next, to be able to sustain a heating wire at 150° C. from its own material at the required heating wire length, the measured value of current must flow. To achieve this, the working voltage is divided by the measured value of current to calculate the required resistance value, and once the final resistance value is obtained, the heating element is fixed with this resistance value and is custom made by embodiment 2, and then the heating element is cut by a predetermined length to make units, and multiple circuits of the units are used by being connected in parallel with each other.

For example, a space of the greenhouse which has a large space for cultivating the crops is to be heated, assuming that the space is wanted to be heated by laying a line of bundle (heating wire) that keeps the temperature of 150° C. for each furrow that has a length of 55 m, when a voltage of 220V is applied by using the heating element manufactured by the embodiments 1 to 8 to cause a current of 4 A to flow through the heating element, when the heating element is continuously heated at a temperature of 150° C., resistance is 220V÷4 A=55Ω.

Herein, when a length of a required heating wire (heating element) to be used is 55 m, the heating element is customized into a heating element having a resistance value of 1Ω per meter by the method of customizing resistance value in embodiment 2, and then the heating element is cut by 55 m to make units with one unit being one circuit, and how many unit are required at the site is determined, then when multiple units are used by being connected in parallel with each other, all of the heating wires installed at the site are maintained at the temperature of 100° C. at the same time.

Accordingly, a large amount of far infrared rays bearing heat at high temperature has a long flying distance and a large amount of radiation is emitted so that the entire greenhouse is heated by far infrared rays (radiant heat) and at the same time uniform heating is possible.

As a result of experimenting the heating element according to the embodiment in various fields, when the heat is generated and maintained at a temperature of 100° C. or more and 1,000° C. or less, the far infrared rays of high temperature fly long, and fly to any wide space at the same time to fill all the space with a large area, and the radiant heating (resonance due to far infrared rays) is performed. With this principle, uniform heating in a large space is possible.

Accordingly, in particular, it is important to heat the heating element according to the embodiment to a high temperature above 100° C., and to achieve this, at least A of current must flow through the heating element according to the embodiment.

Among the heating elements manufactured by this method, an example of a heating element suitable for space heating is as follows:

First, to make the heating element manufactured by the embodiment 8 as a heating wire for the 220V voltage, the heating wire with the resistance value of 2Ω (per 1 m length of the heating element) is cut by 31 m, such that when a current of 220 V 3.1 A is applied, the heating wire continuously maintains a temperature of 150° C. (measured value in the heat accumulation state), whereby it is very effective for large space heating and large space uniform heating.

Second, to make the heating element manufactured by the embodiment 8 as a heating wire for the 220V voltage, the heating wire with the resistance value of 2Ω (per 1 m length of the heating element) is cut by 23 m, such that when a current of 220V 4.2 A is applied, the heating wire continuously maintains a temperature of 230° C. (measured value in the heat accumulation state), whereby it is very effective for large space heating and large space uniform heating.

Third, to make the heating element manufactured by the embodiment 8 as a heating wire for the 380V voltage, the heating wire with the resistance value of 2Ω (per 1 m length of the heating element) is cut by 55 m, such that when a current of 380 V 3.1 A is applied, the heating wire continuously maintains a temperature of 150° C. (measured value in the heat accumulation state), whereby it is very effective for large space heating and large space uniform heating.

Fourth, to make the heating element manufactured by the embodiment 8 as a heating wire for the 380V voltage, the heating wire with the resistance value of 2Ω (per 1 m length of the heating element) is cut by 40 m, such that when a current of 380V 4.2 A is applied, the heating wire continuously maintains a temperature of 230° C. (measured value in the heat accumulation state), whereby it is very effective for large space heating and large space uniform heating.

According to the implementation 1, the fifth and sixth problems of the background art can be solved.

<Implementation 2>

According to the first method (implementation 2), it is possible to make a heating element that operates at low voltage (especially 24V or less), which extends the use range of the heating element to the heating associated with the photovoltaic module.

In the implementation 2, a resistance value per 1 m length of the heating element is reduced to 10Ω or less so that the voltage of the electricity used can be used as low voltage (especially 24V or less).

That is, the implementation 2 is a method in which the heating element manufactured by the above described embodiments 1 to 8 may be used in such a way that after the heating element is manufactured to be operated (reducing a resistance value) in a desired low voltage range (for example, 50V or less), the heating element is cut into a predetermined length to make units, with one unit being one circuit, and multiple circuits of the units are connected in parallel with each other and are used by being connected to a low voltage power supply supplying low voltage power.

Meanwhile, in particular, the heating element is safer to operate in low voltage conditions, and in particular, the worldwide safety voltage is a voltage of 24V or less, and the DC power does not generate a particularly harmful magnetic field of harmful electromagnetic waves.

Based on this, in order to make the heating element operated in a low-voltage band which is harmless to the human body (at least less harmful), it is necessary to use the heating element produced by greatly reducing the heating element resistance value.

That is, went the required low voltage range to be used is low, the resistance value of the heating element must be lowered accordingly, so that a desired amount of current can be supplied to the heating element even at a low voltage. When the current flows smoothly in the heating element, the heating operation is performed.

Further, to lower the heating element resistance value, in the customized method of embodiment 2, the combined resistance value of the ultrafine wire is adjusted to lower the heating element resistance value [symbol] .

For example, If a heating element is wanted to be used as a space heating material for indoor heating of buildings and the power source is used to be directly connected to the solar photovoltaic board, the electricity generated from solar cells produces 1.5V DC of electricity in one cell—usually in a storage battery, and when the storage battery's secondary-side emission voltage is 24V, and the heating connected thereto is wanted to be of 600 W—current is 600 W÷24V=25 A, so a current of at least 25 A should flow to the heating element installed to heat the building, heating is possible with the quantity of heat of 600 W load.

However, to flow a 25 A current to the heating element at 24V, a resistance value of heating element should be 24V=25 A=0.96Ω.

That is, after customizing the heating element to have a resistance value of 0.965 per 1 m length by the embodiment 2, and the same is cut by 1 m to form one circuit.

However, conventional heating elements do not have the technology to lower the heating element resistance value, so they cannot be lowered to less than 30Ω at 1 m length.

Accordingly, if the heating element having a resistance value of 30Ω is applied, a current of 24V÷30Ω=0.8 A flows to the conventional heating element, and if converting this into the amount of power, the amount of power is 24V×0.8 A=19.2 W, only one-third of the desired target load value of 600 W of heat can be achieved, resulting in the building being unable to heat.

If 600 W of heat is to be generated, the conventional heating element having a resistance value of 30Ω per 1 m length is cut by 3 cm, and 31 strands thereof are connected in parallel with each other.

Doing the above cutting greatly reduces the practicality and makes it impossible to make a product.

Accordingly, the low-voltage heating element is only commercially viable if it has a resistance value of at least 10Ω or less per 1 m length, and when making heating elements for low-voltage applications, it is especially necessary to produce resistance values that are at least 10Ω or less per 1 m length.

Next, in order for the heating element having a resistance value of 10Ω or less to operate at the actual low voltage, it is important to connect it to a power supply that can supply the low voltage. The low voltage power supply may be used by being connected to a low voltage AC transformer, a low voltage DC adapter, a storage battery, an energy storage system (ESS), a photovoltaic module (solar cell panel), or equipment with a photovoltaic module (solar cell panel) connected to a storage battery or an ESS.

Further, in particular, the heating element is safer to operate in low voltage conditions, and in particular, the worldwide safety voltage is a voltage of 24V or less, and the DC power does not generate a particularly harmful magnetic field of harmful electromagnetic waves.

Based on this, in the present invention, it is preferable to make a heating element using a voltage of 24 V or lower among low voltages, and it is particularly preferable to use a heating element for DC 24 V or less.

For example, To make a heating element for both AC and DC power supply at voltages below 24V, the heating element is manufactured by the embodiments 1 to 8, the value of current to be used for any particular voltage range below 24V is calculated and a heating element with a customized resistance value is manufactured according to the embodiment 2, and then the heating element is cut by a predetermined length to make unit, and the units are connected in parallel to each other.

To be more specific, assuming that a floor heating material with an amount of power of 192 W per 1 m² that operates at DC 24V is wanted to make and the heating temperature of the heating wire at 100° C. and 150° C. is wanted, firstly, with customized heating elements with different resistance values made by the method, how many degrees (° C.) of temperature is generated when the current flows to each heating element is measured through various experiments to obtain data.

For example, in the heating element of 1Ω, assuming that the continuous heating is performed at a temperature of 150° C., and when 4 A flows and the heating is continued at 100° C., so R=V/I, and thus, 24V÷4 A=6Ω, to adjust 6Ω, a bundle of 1Ω having a length of 6 m is used to be cut as one circuit, wherein the amount of power of one circuit is P=I×V [symbol] 4 A×24V=96 W.

However, the desired amount of power of the floor heating is 192 W, so 192 W÷96 W=2, and thus, two circuits are connected in parallel to each other, and disposed in the floor heating material of 1 m².

If the 6 m of 1Ω is 12 m and the length of the heating wire is too long, it is impossible to arrange it. Therefore, if you have the same 192 W amount of power and you need to shorten the heating wire, a bundle of 2Ω having a length of 3 m is cut, and two circuits are connected in parallel to each other, whereby the total heating wire length is reduced by 6 m.

Conversely, if you want to double the heating wire length, a bundle of 0.5Ω can be used.

If the floor heating material is a DC low-voltage floor heating material, the secondary power supply is connected to DC low voltage (especially DC 24V or less) by using an adapter or a rectifier in the power part.

If you want to connect to the AC low voltage (especially AC 24V or less), the AC low voltage transformer is connected to the power section.

Further, when the power part is connected to the photovoltaic module (solar cell panel), all the electricity generated in the photovoltaic module is DC, so the DC electric power generated here is set to a low voltage (especially DC 24V or less), and the electricity from the module is supplied to the floor heating material.

The electricity generated from the photovoltaic module (solar cell panel) can be stored in ESS (Energy Storage System) such as storage battery and connected to the floor heating material.

According to the implementation 2, the seventh problem can be solved.

<Implementation 3>

According to the third method (implementation 3), using a low voltage (less than 50V), especially, using the voltage less than 24V, it is possible to make the heating element to make the use range thereof even more wider by making heating element generate heat at high temperature over 100° C.

Implementation 3 is a method of manufacturing a heating element that generates a high temperature (100° C. or more) heat at a low voltage (50V or less) by combining the implementations 1 and 2.

In the conventional method, the operating voltage of the heating wire cannot be lowered to less than 24V, which is the global safety voltage. Therefore, when the heating wire is installed in the water, the insulation is problematic so the heating wire cannot be used directly in the water. Thus, the efficiency is further reduced.

However, when the heating wire of the present invention is used, the heating temperature of the heating wire can be raised up to 1000° C. while lowering the voltage to 24V, and even if the heating element insulation is destroyed in water, the working voltage is less than 24V, so it is safe. By placing directly in water, the quantity of heat that is generated is transferred to almost 100% of the water, so the water can be boiled with high efficiency.

To be more specific, the implementation 1 is a method for manufacturing a heating element operating in a low voltage range with high-efficiency, regardless of AC power or DC power.

Accordingly, in manufacturing the heating element, a combined resistance value is adjusted to be suitable for a low voltage of 24V by the implementation 2 (not exceed 10Ω), and the heating element is cut to fit a premeasured value of current to generate heat at a high temperature of 100° C. to 1,000° C. and is used by being connected in parallel to each other, or if the length of the heating element is set in advance, the heating element resistance value is adjusted to the working voltage according to the working voltage and the resistance value according to the used length, and the produced product is cut into a predetermined length and is used by being connected in parallel to each other.

For example, when a water heater boiling water with DC 24V is wanted to make, it is assumed that the water heater is operated only when this DC 24V voltage is used and the heating wire is heated at a high temperature of 500° C.

Firstly, with customized heating elements with different resistance values made by the embodiments 1 to 8, how many degrees of temperature is generated when the current flows to each heating element is measured through various experiments to obtain data.

For example, when a current of 48 A flow to the heating element of 1Ω manufactured by the embodiment 8, if it has been determined that a sustained heat is generated in water at a temperature of 500° C., so 24V÷48 A=0.5Ω, and to adjust to 0.5Ω, the heating element of 1Ω manufactured by the embodiment 8 is cut by 0.5 m to make unit as one circuit.

Further, when the amount of load (amount of power consumption) of the heating element is calculated, it is 24V×48 A=1,152 W.

However, assuming that the desired length of the heating element is already set to be 1 m per circuit, here, the heating element of 1Ω is cut by 1 m, and the two cut units are connected in parallel to each other.

This because, the amount of current flowing to 1 m of the heating element of 1Ω is 24V÷1Ω=24 A, and this is converted into the amount of power consumption, it is 24V×24 A=576 W.

That is, 1,152 W÷576 W=2, whereby the amount of power consumption of using two circuits of 1 m unit of heating element of 1Ω is equal to the amount of power consumption of using one circuit of 0.5 m unit of heating element of 1Ω.

Here, if the heating temperature of 0.5 m unit of heating element of 1Ω is 500° C., the heating temperature of two circuits of 1 m unit of heating element of 1Ω is one/third of the former temperature, 125° C.

According to the implementation 4, the eighth problem can be solved.

<Implementation 4>

The heating element manufactured by the embodiments 1 to 8 in the fourth method (implementation 4) may be used versatile by inserting into a secondary fixture or fixing thereto.

Implementation 4 is a method of fixing the heating element by inserting or attaching the same to a fixture.

To be more specific, first, the heating element manufactured by the embodiments 1 to 8 is coated (or coated more than twice), and the heating element (heating wire) itself is fixed to a fixture to be used.

Here, a coating material used is Teflon, PVC or silicone.

Second, the heating element manufactured by the embodiments 1 to 8 is interposed between upper and lower plates of planar material, then an adhesive is put thereinto, and then the adhesive is melted.

Here, the planar material used is a PET plate, plain fabric, or a tin plate.

Further, the adhesive is a TPU liquid, a TPU plate, a silicone liquid, a silicone plate, a hot-melt liquid, or a hot-melt plate.

Further, melting of the adhesive may be performed by thermal compression using a hot press such that the internal ultrafine wire is impregnated and immobilized while melting the adhesive or may be performed by a high frequency using a high frequency device or a compressor such that the internal ultrafine wire is impregnated and immobilized while melting and pressing the adhesive.

Third, the heating element manufactured by the embodiments 1 to 8 is coated (or coated more than twice), and the heating element (heating wire) itself is fixed to a secondary fixture.

Here, the heating element may be inserted into a wire net such as a cage, fixed in a frame, inserted into a ceiling attachment frame, or secured to a frame such as a wire or metal mesh.

Further, the secondary fixing method is to bind with a binder wire, or to connect the unit of heating element (one circuit) in parallel with a rectangular flexible wire net and fix it with a binder wire (bundle), and then insert the flexible wire into a wire net such as a cage.

<Implementation 5>

The heating element manufactured by the embodiments 1 to 8 through the fifth method (implementation 5) is coated with a special coating to be used in such as snow melting system.

As the implementation 5, to coat the heating element (heating wire) manufactured by the first to third methods with a special coating, after the heating element is coated with a coating and is covered with a shielding shield, the heating element is coated with a coating again.

For example, the surface of the heating element manufactured by the embodiments 1 to 8 is coated with Teflon (once or more than twice), and wrapped with a steel wire (wire with strength) to make a shielding shield, and finally, coated with PVC (once or more than twice), whereby it can be used in snow melting (to melt ice and snow) by inserting it into various road floors, runway floors, artificial turf grounds, golf course floors (or putting in concrete or asphalt).

1. (canceled)

2. (canceled)

3. (canceled)

4. A method for manufacturing a heating element, the method configured in such a way that an ultrafine wire having a high resistance value is formed by using a single metal or an alloy metal, and then a plurality of ultrafine wires formed by using the single metal or the alloy metal are combined to be brought into contact with each other, thereby forming a single bundle resulting in a single-strand heating wire;
a total combined resistance value of the plurality of ultrafine wires is changed to adjust a predetermined resistance value per unit length of the bundle; and
change of the total combined resistance value is performed by at least one method selected from a group consisting of a first method in which the plurality of ultrafine wires are made of a same material and have a same thickness, and a total number of strands of the plurality of ultrafine wires is changed,
a second method in which the plurality of ultrafine wires are made of a same material and have a same number of strands, and a thickness of the plurality of ultrafine wires is changed,
a third method in which the plurality of ultrafine wires have a same thickness and a same number of strands, and a material of the plurality of ultrafine wires is changed,
a fourth method in which the plurality of ultrafine wires have a same thickness and a same number of strands, a material of the plurality of ultrafine wires is different from group to group while making two or more groups with a same material, and the material of the ultrafine wire for each group is changed,
a fifth method in which the plurality of ultrafine wires have a same thickness, a material of the ultrafine wire is different for each group while making two or more groups with a same material, and a number of strands of the ultrafine wires for each group is changed,
a sixth method in which a material of the plurality of ultrafine wires is different from group to group while making two or more groups with a same material, and each group or the bundle has a same number of strands while a thickness of each group is changed, and
a seventh method in which a material of the plurality of ultrafine wires is different from group to group while making two or more groups with a same material, and a thickness and a number of strands of each group are changed, wherein the seventh method is a method configured in such a way that the groups with the same material are divided into a first group and a second group, and in the first group, a thickness and a number of strands of the ultrafine wires are changed, and in the second group, a material thereof is different from a material of the first group and a thickness and a number of strands thereof are same, or a method configured in such a way that the groups with the same material are divided into a first group and a second group, and in the first group, a thickness and a number of strands of the ultrafine wires are changed, and in the second group, a material thereof is different from a material of the first group and a thickness thereof is same and a number of strands thereof is changed.

5. The method of claim 4, wherein of the plurality of ultrafine wires, each ultrafine wire has a same length and a same resistance value, such that a uniform resistance value is achieved along an entire length of the bundle.

6. The method of claim 5, wherein for the each ultrafine wire, a method of making an entire length thereof same and ensuring a uniform resistance value is one of a method in which a metal filament microfiber made of a single metal or an alloy metal through a drawing machine (a wire drawing machine) is used as the ultrafine wire,
a method in which a metal spun microfiber made of a single metal or an alloy metal through a spinning machine is used as the ultrafine wire, and
a method in which a steel fiber (NASLON) is used as the ultrafine wire.

7. The method of claim 6, wherein a method of making the metal filament microfiber through the drawing machine (the wire drawing machine) is a drawing method.

8. A method for manufacturing a heating element, the method configured in such a way that an ultrafine wire having a high resistance value is formed by using a single metal or an alloy metal, and then a plurality of ultrafine wires formed by using the single metal or the alloy metal are combined to be brought into contact with each other, thereby forming a single bundle resulting in a single-strand heating wire; and
the plurality of ultrafine wires are grouped into first and second groups with different functions,
wherein the first group functions to continuously generate heat when current flows, and the second group generates less heat after reaching a predetermined temperature and functions to allow the current to flow like a conductor rather than generating heat as the second group becomes conductive, thereby forming the first and second groups to the single bundle.

9. The method of claim 4, wherein bundling the plurality of ultrafine wires into one bundle is performed by at least one method selected from a group consisting of, a first method of covering the plurality of ultrafine wires with high temperature fiber by wrapping the same with the high temperature fiber along a length direction thereof,
a second method of bundling the plurality of ultrafine wires by twisting the same into one body through a double twister,
a third method of bundling the plurality of ultrafine wires by drawing and coating the same after putting the same into a coating machine, and
a fourth method of bundling the plurality of ultrafine wires by disposing the same between upper and lower plates of planar material, putting an adhesive thereinto, and melting the adhesive.

10. The method of claim 9, wherein in the first method of bundling the plurality of ultrafine wires into one bundle, a material of the high temperature fiber is aramid, polyarylate, or zylon.

11. The method of claim 9, wherein in the third method of bundling the plurality of ultrafine wires into one bundle, a coating material is Teflon, PVC or silicone.

12. The method of claim 9, wherein in the fourth method of bundling the plurality of ultrafine wires into one bundle, the planar material is a PET plate, plain fabric, or a tin plate;
the adhesive is a TPU liquid, a TPU plate, a silicone liquid, a silicone plate, a hot-melt liquid, or a hot-melt plate; and
melting of the adhesive is performed by thermal compression using a hot press to melt the adhesive or by a high frequency using a high frequency device or a compressor.

13. The method of claim 4, wherein a material of the ultrafine wire is made of at least one selected from a group consisting of SUS 316 as a stainless steel alloy, a nickel-copper alloy containing from 20 to 25% by weight of nickel and from 75 to 80% by weight of copper, and an alloy metal containing from 65 to 75% by weight of iron, from 18 to 22% by weight of chromium, from 5 to 6% by weight of alumina, and from 3 to 4% by weight of molybdenum.

14. The method of claim 13, wherein the alloy metal is added with silicone, manganese, and carbon.

15. The method of claim 4, wherein a material of the ultrafine wire generates far infrared rays when heat is applied thereto.

16. A heating element being one bundled heating wire as a parallel combined structure configured such that a plurality of ultrafine wires having a high resistance value are brought into contact with each other to be bundled,
wherein the plurality of ultrafine wires is constituted by a first group and a second group with different materials or constituted by a first group and a second group with different heating functions.

17. The heating element of claim 16, wherein a material of the ultrafine wire is a single metal, alloy metal, or a steel fiber.

18. (canceled)

19. A heating element being one bundled heating wire as a parallel combined structure configured such that a plurality of ultrafine wires having a high resistance value are brought into contact with each other to be bundled, and
a material of the ultrafine wires is two different kinds of material, wherein the ultrafine wires made of same material of the two materials have a same thickness, and ultrafine wires of one material have a thickness and a number of strands different from a thickness and a number of strands of ultrafine wires of the other material,
wherein one material of the two materials is SUS 316 or NASLON of steel fiber, with one strand of ultrafine wire having a thickness of 12 μm and a number of strands being 550,
the other material of the two materials is nickel-copper single metal containing from 20 to 25% by weight of nickel and from 75 to 80% by weight of copper, with one strand of ultrafine wire having a thickness of 100 μm (a resistance value of 36Ω per strand) and a number of strands being 24, and
the two materials are bundled into one such that a resistance value per 1 m length of heating wire is 1Ω.

20. A heating element being one bundled heating wire as a parallel combined structure configured such that a plurality of ultrafine wires having a high resistance value are brought into contact with each other to be bundled, and
a material of the ultrafine wires is two different kinds of material, wherein the ultrafine wires made of same material of the two materials have a same thickness, and ultrafine wires of one material have a thickness and a number of strands different from a thickness and a number of strands of ultrafine wires of the other material,
wherein one material of the two materials is SUS 316 or NASLON of steel fiber with one strand of ultrafine wire having a thickness of 8 μm and a number of strands being 1,000,
the other material of the two materials is nickel-copper single metal containing from 20 to 25% by weight of nickel and from 75 to 80% by weight of copper, with one strand of ultrafine wire having a thickness of 100 μm (a resistance value of 36Ω per strand) and a number of strands being 24, and
the two materials are bundled into one such that a resistance value per 1 m length of heating wire is 1Ω.

21. A heating element being one bundled heating wire as a parallel combined structure configured such that a plurality of ultrafine wires having a high resistance value are brought into contact with each other to be bundled, and
a material of the ultrafine wires is two different kinds of material, wherein the ultrafine wires made of same material of the two materials have a same thickness, and ultrafine wires of one material have a thickness and a number of strands different from a thickness and a number of strands of ultrafine wires of the other material,
wherein one material of the two materials is SUS 316 or NASLON of steel fiber with one strand of ultrafine wire having a thickness of 6.5 μm and a number of strands being 2,000,
the other material of the two materials is nickel-copper single metal containing from 20 to 25% by weight of nickel and from 75 to 80% by weight of copper, with one strand of ultrafine wire having a thickness of 100 μm (a resistance value of 36Ω per strand) and a number of strands being 24, and
the two materials are bundled into one such that a resistance value per 1 m length of heating wire is 1Ω.

22. A heating element being one bundled heating wire as a parallel combined structure configured such that a plurality of ultrafine wires having a high resistance value are brought into contact with each other to be bundled, and
a material of the ultrafine wires is two different kinds of material, wherein the ultrafine wires made of same material of the two materials have a same thickness, and ultrafine wires of one material have a thickness and a number of strands different from a thickness and a number of strands of ultrafine wires of the other material,
wherein one material of the two materials is SUS 316 or NASLON of steel fiber with one strand of ultrafine wire having a thickness of 100 μm and a number of strands being 40,
the other material of the two materials is nickel-copper single metal containing from 20 to 25% by weight of nickel and from 75 to 80% by weight of copper, with one strand of ultrafine wire having a thickness of 100 μm (a resistance value of 36Ω per strand) and a number of strands being 24, and
the two materials are bundled into one such that a resistance value per 1 m length of heating wire is 1Ω.

23. A heating element being one bundled heating wire as a parallel combined structure configured such that a plurality of ultrafine wires having a high resistance value are brought into contact with each other to be bundled, and
a material of the ultrafine wires is two different kinds of material, wherein the ultrafine wires made of same material of the two materials have a same thickness, and ultrafine wires of one material have a thickness and a number of strands different from a thickness and a number of strands of ultrafine wires of the other material,
wherein one material of the two materials is SUS 316 or NASLON of steel fiber with one strand of ultrafine wire having a thickness of 12 μm and a number of strands being 550,
the other material of the two materials is nickel-copper single metal containing from 20 to 25% by weight of nickel and from 75 to 80% by weight of copper, with one strand of ultrafine wire having a thickness of 100 μm (a resistance value of 36Ω per strand) and a number of strands being 14, and
the two materials are bundled into one such that a resistance value per 1 m length of heating wire is 2Ω.

24. A heating element being one bundled heating wire as a parallel combined structure configured such that a plurality of ultrafine wires having a high resistance value are brought into contact with each other to be bundled, and
a material of the ultrafine wires is two different kinds of material, wherein the ultrafine wires made of same material of the two materials have a same thickness, and ultrafine wires of one material have a thickness and a number of strands different from a thickness and a number of strands of ultrafine wires of the other material,
wherein one material of the two materials is SUS 316 or NASLON of steel fiber with one strand of ultrafine wire having a thickness of 8 μm and a number of strands being 1000,
the other material of the two materials is nickel-copper single metal containing from 20 to 25% by weight of nickel and from 75 to 80% by weight of copper, with one strand of ultrafine wire having a thickness of 100 μm (a resistance value of 36Ω per strand) and a number of strands being 14, and
the two materials are bundled into one such that a resistance value per 1 m length of heating wire is 2Ω.

25. A heating element being one bundled heating wire as a parallel combined structure configured such that a plurality of ultrafine wires having a high resistance value are brought into contact with each other to be bundled, and
a material of the ultrafine wires is two different kinds of material, wherein the ultrafine wires made of same material of the two materials have a same thickness, and ultrafine wires of one material have a thickness and a number of strands different from a thickness and a number of strands of ultrafine wires of the other material,
wherein one material of the two materials is SUS 316 or NASLON of steel fiber with one strand of ultrafine wire having a thickness of 6.5 μm and a number of strands being 2000,
the other material of the two materials is nickel-copper single metal containing from 20 to 25% by weight of nickel and from 75 to 80% by weight of copper, with one strand of ultrafine wire having a thickness of 100 μm (a resistance value of 36Ω per strand) and a number of strands being 14, and
the two materials are bundled into one such that a resistance value per 1 m length of heating wire is 2Ω.

26. A heating element being one bundled heating wire as a parallel combined structure configured such that a plurality of ultrafine wires having a high resistance value are brought into contact with each other to be bundled, and
a material of the ultrafine wires is two different kinds of material, wherein the ultrafine wires made of same material of the two materials have a same thickness, and ultrafine wires of one material have a thickness and a number of strands different from a thickness and a number of strands of ultrafine wires of the other material,
wherein one material of the two materials is SUS 316 or NASLON of steel fiber with one strand of ultrafine wire having a thickness of 100 μm and a number of strands being 40,
the other material of the two materials is nickel-copper single metal containing from 20 to 25% by weight of nickel and from 75 to 80% by weight of copper, with one strand of ultrafine wire having a thickness of 100 μm (a resistance value of 36Ω per strand) and a number of strands being 14, and
the two materials are bundled into one such that a resistance value per 1 m length of heating wire is 2Ω.

27. The heating element of claim 23, wherein the heating wire with the resistance value of 2Ω per 1 m length is cut by 31 m such that when a current of 220 V 3.1 A is applied, the heating wire continuously maintains a temperature of 150° C. (measured value in the heat accumulation state).

28. The heating element of claim 23, wherein the heating wire with the resistance value of 2Ω per 1 m length is cut by 23 m such that when a current of 220V 4.2 A is applied, the heating wire continuously maintains a temperature of 230° C. (measured value in the heat accumulation state).

29. The heating element of claim 23, wherein the heating wire with the resistance value of 2Ω per 1 m length is cut by 55 m such that when a current of 380 V 3.1 A is applied, the heating wire continuously maintains a temperature of 150° C. (measured value in the heat accumulation state).

30. The heating element of claim 23, wherein the heating wire with the resistance value of 2Ω per 1 m length is cut by 40 m such that when a current of 380V 4.2 A is applied, the heating wire continuously maintains a temperature of 230° C. (measured value in the heat accumulation state).

31. A heating element being one bundled heating wire as a parallel combined structure configured such that a plurality of ultrafine wires having a high resistance value are brought into contact with each other to be bundled, and
a material of the ultrafine wires is two different kinds of material, wherein the ultrafine wires made of same material of the two materials have a same thickness, and ultrafine wires of one material have a thickness and a number of strands different from a thickness and a number of strands of ultrafine wires of the other material,
wherein one material of the two materials is SUS 316 or NASLON of steel fiber, with one strand of ultrafine wire having a thickness of 12 μm and a number of strands being 550,
the other material of the two materials is nickel-copper single metal containing from 20 to 25% by weight of nickel and from 75 to 80% by weight of copper, with one strand of ultrafine wire having a thickness of 100 μm (a resistance value of 36Ω per strand) and a number of strands being 9, and
the two materials are bundled into one such that a resistance value per 1 m length of heating wire is 3Ω.

32. A heating element being one bundled heating wire as a parallel combined structure configured such that a plurality of ultrafine wires having a high resistance value are brought into contact with each other to be bundled, and
a material of the ultrafine wires is two different kinds of material, wherein the ultrafine wires made of same material of the two materials have a same thickness, and ultrafine wires of one material have a thickness and a number of strands different from a thickness and a number of strands of ultrafine wires of the other material,
wherein one material of the two materials is SUS 316 or NASLON of steel fiber, with one strand of ultrafine wire having a thickness of 8 μm and a number of strands being 1000,
the other material of the two materials is nickel-copper single metal containing from 20 to 25% by weight of nickel and from 75 to 80% by weight of copper, with one strand of ultrafine wire having a thickness of 100 μm (a resistance value of 36Ω per strand) and a number of strands being 9, and
the two materials are bundled into one such that a resistance value per 1 m length of heating wire is 3Ω.

33. A heating element being one bundled heating wire as a parallel combined structure configured such that a plurality of ultrafine wires having a high resistance value are brought into contact with each other to be bundled, and
a material of the ultrafine wires is two different kinds of material, wherein the ultrafine wires made of same material of the two materials have a same thickness, and ultrafine wires of one material have a thickness and a number of strands different from a thickness and a number of strands of ultrafine wires of the other material,
wherein one material of the two materials is SUS 316 or NASLON of steel fiber, with one strand of ultrafine wire having a thickness of 6.5 μm and a number of strands being 2000,
the other material of the two materials is nickel-copper single metal containing from 20 to 25% by weight of nickel and from 75 to 80% by weight of copper, with one strand of ultrafine wire having a thickness of 100 μm (a resistance value of 36Ω per strand) and a number of strands being 9, and
the two materials are bundled into one such that a resistance value per 1 m length of heating wire is 3Ω.

34. A heating element being one bundled heating wire as a parallel combined structure configured such that a plurality of ultrafine wires having a high resistance value are brought into contact with each other to be bundled, and
a material of the ultrafine wires is two different kinds of material, wherein the ultrafine wires made of same material of the two materials have a same thickness, and ultrafine wires of one material have a thickness and a number of strands different from a thickness and a number of strands of ultrafine wires of the other material,
wherein one material of the two materials is SUS 316 or NASLON of steel fiber, with one strand of ultrafine wire having a thickness of 100 μm and a number of strands being 40,
the other material of the two materials is nickel-copper single metal containing from 20 to 25% by weight of nickel and from 75 to 80% by weight of copper, with one strand of ultrafine wire having a thickness of 100 μm (a resistance value of 36Ω per strand) and a number of strands being 9, and
the two materials are bundled into one such that a resistance value per 1 m length of heating wire is 3Ω.

35. (canceled)

36. The heating element of claim 16, wherein the ultrafine wire of the heating element is made of a material generating far infrared rays when heat is applied thereto, thereby keeping a heating temperature of 100° C. to 1000° C.

37. (canceled)

38. (canceled)

39. The heating element of claim 16, wherein a value of current of 3 A or more flows through the heating element to generate heat at a temperature of 100° C. or more.

40. (canceled)

41. The heating element of claim 16, wherein a resistance value per unit length of the heating element is reduced such that the heating element is operated in a low voltage range of 50V or less.

42. The heating element of claim 41, wherein a resistance value per 1 m length of the heating element is 10Ω or less.

43. (canceled)

44. The heating element of claim 16, wherein the heating element is operated in a low voltage range of AC 24V or less, or in a low voltage range of DC 24V or less.

45. (canceled)

46. (canceled)

47. (canceled)

48. (canceled)

49. (canceled)

50. (canceled)
